(19) United States
(12) Patent Application Publication
(10) Pub. No.: US 2014/0265750 A1
(43) Pub. Date: Sep. 18, 2014

(54) SYSTEM AND METHOD FOR GENERATING ELECTRICITY FROM GRAVITATIONAL FORCES

(71) Applicant: PST Associates, Inc., Chapel Hill, NC (US)

(72) Inventors: Michael H. Graff, Melbourne, FL (US); Douglas Torr, Chapel Hill, NC (US)

(73) Assignee: PST Associates, Inc., Chapel Hill, NC (US)

(21) Appl. No.: 14/208,610

(22) Filed: Mar. 13, 2014

Related U.S. Application Data
(60) Provisional application No. 61/783,025, filed on Mar. 14, 2013.
(60) Provisional application No. 61/782,954, filed on Mar. 14, 2013.

(51) Int. Cl. H02K 3/00

(52) U.S. Cl. CPC H02K 3/00
USPC 310/68 R; 310/195

(57) ABSTRACT

A motor is provided. The motor includes a winding support element defining an interior, a rotor having a shaft mounted inside the interior, the shaft defining a central axis, a superconducting wire wound around the winding support element in a winding pattern, where the winding pattern includes a plurality of turns around the winding support element. The winding pattern includes for a first portion of each turn proximate to the rotor, the wiring pattern curves with respect to a toroidal angle about the central axis, and for a second portion of each turn distant from the rotor, the wiring pattern curves with respect to a toroidal angle about the central axis. Cooper pairs travelling through the wire accelerate with respect to the toroidal angle in the first portion, and decelerate with respect to the toroidal angle in the second portion.

### CROSS REFERENCE TO RELATED APPLICATIONS

This document claims priority to a U.S. Provisional Patent Applications 61/783,025 entitled PSTA THEORETICAL APPROACH TO POWER GENERATION TECHNOLOGY and 61/782,954 entitled SYSTEM AND METHOD FOR GENERATING THRUST FROM GRAVITY APPLICATIONS, both filed Mar. 14, 2013, the contents of which are herein incorporated by reference in their entireties.

### BACKGROUND

The present invention relates to producing rotational motion in a rotor through the generation of a gravity field. More specifically, the present invention relates to using a novel winding geometry of superconducting coils to generate a gravity field that operates on the mass of a rotor to induce rotation, which in turn can be used to drive a generator to generate electricity.

Various attempts have been made to design systems that manipulate gravitational effects to produce electricity. Such attempts have not proven successful.

### BRIEF DESCRIPTION OF THE DRAWINGS

FIG. 1 is a perspective view of an embodiment of the invention.

FIG. 2 is an exploded view of an energy transfer device according to the embodiment of FIG. 1.

FIG. 3 is an exploded view of the cryostat and superconducting toroidal coils according to the embodiment of FIG. 2.

FIG. 4 is a cross section of the cryostat according to the embodiment of FIG. 2.

FIG. 5 is a perspective view of a toroid winding support element of the embodiment of FIG. 2.

FIG. 6 is a cross sectional view of the toroid winding support element of FIG. 5 taken across line A-A.

FIG. 7 is a perspective view of a toroid winding support element with a single winding of superconductor wire.

FIG. 8 is a perspective view of a toroid winding support element and a map of the pathway taken by a superconductive wire around the toroid winding support element.

FIG. 9 shows the component of velocity projected as s function of φ onto the earth's velocity.

FIG. 10 is a perspective view of a toroid winding support element with two windings of superconductor wire.

FIG. 11 is a perspective view of a toroid winding support element with several windings of superconductor wire.

FIGS. 12A-F are cross sections of various methodologies for guiding and/or attaching superconducting wire.

FIG. 13 is a cross section of the energy transfer motor of the embodiment of FIGS. 1-3.

FIG. 14 is a schematic of an embodiment of a methodology for inducing initial motion of cooper pairs in a semiconductor.

FIG. 15 is a collection of radial cross sectional views of toroid winding support elements according to possible embodiments of the invention.

FIG. 16 is a collection of axial cross sectional views of toroid winding support elements according to possible embodiments of the invention.

FIG. 17 is a perspective view of an energy transfer device with a speed control mechanism.

FIG. 18 is a perspective view of an energy transfer device mounted on a rotating platform.

FIG. 19 is an exploded view of the inner container according to the embodiment of FIG. 2, utilizing another embodiment of a toroid winding support element.

FIG. 20 is a front view of the toroid winding support element of FIG. 19.

FIG. 21 is a front view of a portion of the toroid winding support, element of FIG. 20.

FIG. 22 is a perspective view of a portion of the toroid winding support element of FIG. 20.

FIG. 23 is a perspective view of a portion of the toroid winding support element of FIG. 20 with superconducting wire laid therein.

FIGS. 24 and 25 is a map of the pathway taken by a superconductive wire around the toroid winding support element in FIG. 23.

FIG. 26 is a cross section of an embodiment of the invention with the toroid winding support element of FIG. 19.

FIG. 27 is a conceptual schematic of net torque induced by movement of cooper pairs.

FIG. 28 is a perspective view of a toroid winding support element with a single winding of superconductor wire.

FIG. 29 is a zoom in view of a meandering pattern of the wire in FIG. 28.

FIG. 30 is a zoom in view of a meandering pattern of the wire in FIG. 29 with an internal meandering internal conductive pattern.

FIG. 31 is a zoom in view of a meandering pattern of the wire in a zig zag pattern.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Referring now to FIG. 1, a generator 100 of the invention is shown. Generator 100 includes three sections: an energy transfer device 110, an electrical generator 120, and an interface 130.

Referring now to FIG. 2, an exploded view of energy transfer device 110 is shown in more detail. Energy transfer device includes three coaxial components: an outer casing 210, an inner container 220, and a rotor 230 having a shaft 240. Supports 270 (only one is shown in FIG. 2) may be provided around the periphery of inner container 220 to support inner container 220 relative to outer casing 210.

The various components are preferably aligned as follows. The rotor 230 is mounted within an internal axial cavity of inner container 220, and the combination of rotor 230 and inner container 220 are mounted within outer casing 210. Two end plates 260 and 280 seal both ends of the outer casing 210 with inner container 220 and rotor 230 inside. Shaft 250 extends through at least one of the side plates 260 and 280 through a bearing 240 with a vacuum seal (only one side of shaft 250 so emerging from plate 280 is shown in the figures).

The various components may be assembled and/or mounted together through various support, plates, welds, nuts/bolts, etc. The invention is not limited to any particular mounting and/or assembly methodology. FIG. 2 shows a non-limiting example in which rotor 230 and inner container 220 are previously mounted on plate 280; this collective component is then mounted inside outer casing 210 and sealed by plate 260.

Referring now to FIGS. 3 and 4, an exploded view and cross sectional view of the inner container 220 is shown. Inner container 220 is a cryostat that maintains cryogenic temperatures of the components mounted therein. The outer portion of inner container 220 is generally defined by shell 310. Shell 310 in FIG. 3 is in the shape of a toroid with a rectangular cross section, and thus has an outer wail 312 and an inner wall 314. Inner wall 314 defines an interior cavity 316 into which rotor 230 can be inserted. The space between outer wall 312 and inner wall 314 defines a cryogenic chamber 318. End plates 320 and 322 seal off the lateral ends of shell 310.

A group of toroid winding support elements 330 (five are shown in FIG. 3) with surrounding superconductor material (not shown in FIG. 3) are inserted into cryogenic chamber 318. For ease of explanation, discussion herein is limited to five (5) such toroid winding support elements. However, it is to be understood that any number (including one) may be present.

Lateral and longitudinal spacers 340 may be provided between adjacent toroid winding support elements 330 and at the lateral ends adjacent plates 320 and 322 to such that each toroid winding support element 330 is separated from other toroid winding support elements 330 and shell 310. As discussed more fully below, this gap will allow cooling fluid to circulate around toroid winding support elements 330.

Referring now to FIGS. 5 and 6, a toroid winding support element 330 is shown. The toroid winding support element 330 preferably has a toroid shape about a central axis 510, made from a single component or multiple components connected together, that fits within inner container 220. An example of a non-limiting cross section of toroid is a substantially rectangular shape. The shape could have distinct edges, but for reasons discussed below one or more may have rounded corners or edges as shown in FIG. 6. Toroid winding support element 330 is preferably made from materials that provide physical support to superconductor windings in their operating environments, such as carbon fiber; the nature of such materials are known to those in the art of superconductors and are not discussed further herein.

A coordinate system is useful for discussing certain aspects of toroid winding support element 330. As noted above, there is a central axis Z 510. There is a radial axis R that extends through and perpendicular to the central axis Z in all directions, such as 520. There is a poloidal angle 525 around the radial axis r, referred to herein as theta (“θ”). There is also a toroidal angle 530 around the central axis 510, referred to herein as phi (“φ”). Finally, there is a toroidal angle 535 around the radial axis 520, referred to herein as alpha (“α”).

As discussed above, each toroid winding support element 330 supports a superconductor material. Referring now to FIG. 7, a superconducting wire 710 is wound around the toroid winding support element 330. Although from the figure it may appear that superconducting wire 710 forms multiple closed loops, it is in fact a single wire with two ends (not shown in FIG. 7) making multiple turns around the toroid winding support element.

Referring now to FIG. 8, the superconducting wire 710 is wound in a prescribed pattern around toroid winding support element 330. The nature of the pattern is best described with respect to the four (4) faces of toroid winding support element, which includes the inner face A, the outer face C, and the intervening side faces B and D. These faces are illustrated in FIG. 8 for reference as unfolded onto a planar coordinate system corresponding to the θ-φ toroidal coordinates, although it is to be understood that this θ-φ representation is for illustration only.

For ease of reference, the two ends 810 and 890 of the superconductor 710 are shown at the juncture of the C and D surfaces of support 330, but it should be understood that superconductor 710 may continue beyond those points, such as for additional turns and/or to connect to other circuitry not shown.

In the embodiment of FIG. 8, superconducting wire 710 is laid along face D and runs toward face A. In this zone 815, the wire 710 is substantially linear; in the toroidal coordinate system, wire 710 does not have any change along the φ (phi) axis, but it does change in radial distance R from the central Z-axis.

At the transition of the faces D and A at 820, wire 710 is laid in a zone 825 along face A to define a curve. Non-limiting examples of mathematics that may define the particular path of the curve are discussed below. For purposes of illustration, the pathway preferably has a changing slope as viewed in the planar illustration, based on a relationship φ=θⁱ, where i>1. A parabolic curve (i=2) may be used, but other functions may be used with greater values of i preferred. In the coordinate system illustrated in FIG. 5, the pathway in zone 825 along face A is changing in the axial direction (Z) 510 and in toroidal angular direction (φ) 530, but not in radial direction (R) 520.

The curved pathway of zone 825 continues across from face A and into face B. In the toroidal coordinate system illustrated in FIG. 5, the pathway of zone 825 on face B is changing in the radial direction (R) 520 and in the toroidal angular direction (φ) 530, but not in the axial direction (Z) 520.

Over the length of zone 825, the curve may hold to a specific mathematical formula, or may vary.

Within face B, at 830 the pathway of wire 710 transitions from the curve in zone 825 to a substantially linear pathway in zone 835, i.e., i=1. In the toroidal coordinate system illustrated in FIG. 5, the pathway of zone 835 on face B is changing in the radial direction (R) 520 and in toroidal angular direction (φ) 530, but not in the axial direction (Z) 510.

At the transition of the wire pathway from face B to face C at 840, the wire 710 returns to a substantially linear pathway along zone 845. This continues along the entire surface efface C. In the toroidal coordinate system illustrated in FIG. 5, the wire 710 is substantially aligned along the axial direction (Z) 510, but does not extend in the radial direction (R) 520 or in the toroidal angular direction (φ) 530.

In the above, the transition points, such as transition point 840 may be small zones with a small but non-zero length, for example, to accommodate a minimum wire bend radius, although they are preferably significantly smaller than the other zones A, B, C and D.

The wire 710 then continues into a second turn (connected at k) onto surface of face A for a new zone 815. The winding of wire 710 continues as discussed above.

As discussed above, toroid winding support element 330 preferably has rounded corners rather than sharp ones, which facilitates winding of wire 710 around toroid winding support element 330.

The rationale for the specific layout relates to how a particle pair—particularly a cooper pair within the superconducting wire 710 under proper environmental conditions—moves along a pathway described above. Due to the nature of a superconductor, once a power supply is applied to the wire 710, cooper pairs within wire 710 under appropriate superconducting environmental conditions will continue to move through the superconducting wire 710 at a substantially constant velocity and substantially zero acceleration with respect to the entire length of wire 710.

However, the velocity and acceleration are not constant with respect to the toroidal angle φ. Referring now to FIG. 9, in zone 815, there is no change in toroidal angle φ, such that for a particle the velocity with respect to toroidal angle φ (velocity (φ)) and the acceleration with respect to toroidal angle φ (acceleration (φ)) are both zero. In zone 825, the curve in the wire pathway generates an acceleration relative to toroidal angle (acceleration (φ)>0) with a corresponding increase in velocity. In zone 835, the linear nature of the wire pathway returns acceleration with respect to toroidal angle φ back to zero (acceleration (φ)=0), but maintains a velocity with respect to toroidal angle φ. At zone 840, there is a sudden shift from the angled pathway to the horizontal in zone 845. Zone 845 induces a significant deceleration with respect to toroidal angle φ (acceleration (φ)<<0) to return the velocity with respect to toroidal angle φ back to zero.

As discussed above, a characteristic of a single turn is that cumulative acceleration along a 360° turn of the toroidal angle φ remains at substantially zero. Thus, whatever acceleration created in zone 825 is offset by the deceleration in zone 840. Since zone 825 in the above embodiments is much longer than zone 840, the deceleration is particularly acute (<<0).

The winding pattern is based on a principle that the acceleration of cooper pairs within the superconducting windings induces a force on a nearby mass as illustrated generically in FIG. 27. Cooper pairs accelerating in phi (φ) around a ring of superconducting material 2702 induce gravitational field proportional to the magnitude of the acceleration. A mass element will experience a force in the same direction as the cooper-pair acceleration. The magnitude of the force drops off according to the square of the distance of the mass from the point(s) of cooper-pair acceleration. Rotor 2704 is mounted about a shaft 2706 concentrically within the ring 2702 will experience a net torque 2708. The winding pattern discussed with respect to FIG. 8 above is exemplary only to achieve cooper pair acceleration. Other options and overarching methodologies are discussed in more detail below in connection with the underlying scientific principles of the embodiment.

Referring back to FIG. 7, the winding pattern discussed with respect to FIG. 8 traverses completely around the toroid winding support element, that is, makes a 360-degree transit in phi (φ). The pitch (distance in the phi direction required for a single turn) may be larger than the wire diameter. Referring now to FIG. 10, the winding of superconducting wire 710 continues around supporting element 330 to interlace with the first turns; the second set of turns follows the same pattern (albeit not pathway, as there is some lateral offset) as the first set of turns. This process continues until the supporting element 330 is covered to a desired extent; FIG. 11 shows the bulk of the surface of the toroid winding support element 330 so covered.

In the above embodiment, the winding may only be one layer deep. However, the invention is not so limited, and windings may continue for several layers. Also, in the above embodiment the wire 710 is a single wire, but again the invention is not so limited, as several different wires could be so wound; provided that they would be independently actuated.

It may be desirable to provide various mechanical structures to support the laying of wire 710 in the desired pattern. One such reason for this is the effect of the Lorenz law, per which the passage of electrons though the superconducting wire in the presence of a magnetic field will generate forces that may move wire 710 from its desired position.

Referring to FIG. 12A, one such mechanical structure is a simple adhesive 1210 that could survive the extremely low temperatures under which superconductors operate.

Referring now to FIG. 12B, another such mechanical structure is a series of protrusions or fences 1220 along the outer surface of toroid winding support element 330 that act as guides. The fence 1220 follows the pattern shown in FIG. 8. The wire 710 is initially laid along the fence 1220, then the next winding is nested against the prior winding, and so on. There is no particular limit on the number offences, although it may be appropriate to have one such fence per turn of wire in the winding; thus by way of non-limiting example, if there are 16 turns in the winding shown in the FIG. 7, then the fence 1220 could similarly extend continuously around the surface of toroid winding support element 330 for 16 turns. In this configuration, 99+% of the supporting element 330 could be covered with superconducting wire 710.

Referring now to FIG. 12C, another such mechanical structure is a groove 1230 cut into toroid winding support element 330. The methodology for forming grooves into toroid winding support elements to support semiconducting wires is known in the art, such as in U.S. Pat. No. 7,915,990, issued Mar. 29, 2011 entitled “Wiring assembly and method for positioning conductor in a channel having a flat surface portion”, the contents of which are expressly incorporated by reference in its entirety.

FIGS. 12D-F correspond to FIGS. 12A-C, save that the wire 710 is shown with multiple overlapping windings.

Returning to FIG. 2, toroid winding support elements 330 bearing the superconducting wires 710 are mounted inside inner container 220, and assembled in the configuration shown in FIG. 1. A cross section of the resulting energy transfer motor 110 is shown in FIG. 13.

Referring now to FIG. 13, the assembled energy transfer motor 110 is shown. A vacuum pump (not shown) connects through a fitting 1310 to evacuate the area between outer casing 210 and inner container 220, and also between the inner container 220 and the rotor 230 and also between the rotor 230 and the end plates 280 and 260 and sets that area to a vacuum to provide a temperature insulator as well as eliminating friction against the rotor 230 from air. Vacuum seal 240 allows shaft 250 to transition from the vacuum inside outer casing 210 to normal atmospheric pressure outside.

Inner container 220 is filled with a liquid and/or gaseous refrigerant, which can circulate around the gaps between the supporting elements 330 established by the spacers 370. The refrigerant is of a low enough temperature to achieve the critical temperature for superconducting wire 710 to enter a superconducting state; liquid helium is suitable for this purpose, although other refrigerants as may be appropriate for the selected superconductive material of superconductor wire 710 may also be used. A cooling device 1320 may connect to inner container 220 to remove evaporating refrigerant, cool the same and return the refrigerant back to inner container 220.

Referring now to FIG. 14, the superconducting wires 710 wound around toroid winding support elements 330 will initially require some energy to initiate movement of the cooper pairs. One such methodology is to provide wires 710 with a basic low voltage high current power supply (e.g., 1-2 volts, 1-10k amps) or flux pump, shown in FIG. 14 genetically as power supply 1410. Once the cooper pairs are energized and in motion, the power supply 1410 is disconnected via switch 1420 and the wire 710 shorted with superconducting material 1430. The methodology for initiating movement of cooper pairs in this manner is well known in the art of superconductors and not discussed further herein. Power supply 1410 could be positioned inside or outside of external casing 210, provided appropriate interfaces were provided to reach wires 710. The methodology for initiating this internal motion is known to those of skill in the art of superconductors, and not further described herein.

The operation of the energy transfer motor will now be discussed. The cooper pairs are energized within superconductive wire 710 as discussed above. As is known in the art, superconducting wire 710—which is below its critical temperature due to the refrigerant—will allow the cooper pairs to circulate indefinitely within the windings around toroid winding support element 330.

When the cooper pairs are in a geometric zone in which they are accelerating with respect to phi, such as for example zone 825, the cooper pairs will generate a corresponding gravitational field. This field exerts a torque on rotor 230 causing it to rotate around axis 510, which coincides with shaft 250.

Similarly, when the cooper pairs are in a zone in which they are decelerating such as zone 840, the cooper pairs will generate a corresponding gravity field in the opposite direction to zone 825.

Since the total acceleration of the cooper pairs around a turn is equal to zero, the acceleration-induced torque could offset the deceleration. Further, the gravity generated by the deceleration, by virtue of its opposite direction, counteracts the effects applied by the gravity generated by acceleration.

However, while the gravity created by acceleration and deceleration of the cooper pairs are equal, they do not have equal effects on rotor 230. This is because the zone of acceleration 825 is primarily on the internal face A of toroid winding support element 330, which is closest to rotor 203. In contrast, the zone of deceleration 840 is at the transition of face D and C, which is further away from the rotor than the zone of acceleration. Based on a principle that the effect of the field component is proportional to 1/r² (where r is the distance from the point of cooper-pair acceleration to a mass element), the further a zone is from the rotor 230, the less influence it will have. As a result, the torque induced by the proximate zone of acceleration 825 is greater than the counter torque induced by the zone of deceleration 840. Thus, there is a non-zero net effect on the rotor 230, which exerts a torque to rotate rotor 230.

The embodiment of FIG. 7 uses a wiring path with zone of acceleration 825 occurring at a different distance from rotor 230 than zone of deceleration 840. Other configurations in which the areas closer to rotor 230 generate net positive (or negative) acceleration while the areas further from rotor 230 generate net negative (or positive) cooper-pair acceleration may be used.

Further, the layout of wires 710 does not require perfection in mechanical accuracy to produce this result. There may be an optimal layout that will generate the greatest overall torque, and mechanical accuracy may yield the most perfect implementation of that design. Yet the design still works absent that accuracy, and relaxation of the accuracy may allow for more wire 710 to be laid (e.g., wire 710 laid in fences 1220 is less accurate than grooves 1230, but fences 1220 may allow for more wire 710) to generate higher overall torque yield.

All of the above being said, the velocity of movement of the cooper pair through wire 710 in and of itself may not be sufficient to generate a desired amount of torque on rotor 230. A velocity component may be exploited to contribute to the gravity field.

Such a velocity component is in fact available, as the cooper pairs are moving relative to Earth, which is in turn moving relative to a position in space. More specifically, the Earth as a celestial body is moving away from the origin point of the universe. The Earth is moving through space in a direction approximate to the true north-south axis of the Earth, and at a speed of approximately 1.3% of the speed of light. For discussion purposes this is referred to herein as Earth velocity. Although the foundation of the same is not necessary for implementation of the embodiments discussed herein, by way of reference the underlying physics is discussed in more detail in Applicants' incorporated by reference U.S. Provisional patent application entitled PSTA THEORETICAL APPROACH TO POWER GENERATION TECHNOLOGY.

Under theories of relativity, energy from the Earth velocity ordinarily cannot be harnessed because any particle from which it would be harnessed is moving in the same speed and direction as the environment that supports the particle; relative to each other, the particle and the environment do not have such energy to capture. However, such relativistic relationship breaks down in the environment of operating superconductors.

Since the energy of Earth velocity is not omni-directional, but rather in the specific direction of approximately the true north-south axis of the Earth, energy transfer device 110 benefits from an orientation to capture the effect of the Earth's velocity on the cooper pairs. (By way of analogy, a boat sail must be in a particular orientation to capture the wind, although the underlying physics is different.) To capture that energy, the central axis 510, and thus shaft 250, is preferably aligned perpendicular to the direction of Earth velocity, i.e., approximately on an east-west orientation.

When in this orientation and under superconducting environmental conditions, the velocity of the cooper pairs as measured relative to the Earth becomes only a portion of the overall kinetic energy, in that the Earth velocity is approximately 1.3% of the speed of light. The effect of the cooper pairs is proportional to the product of their velocity (as measured with respect to the Earth) and the relatively large absolute velocity of the Earth (as measured in a frame of reference attached to the universe point of origin). The gravity field generated from cooper-pair acceleration that is aligned with the Earth's velocity is significantly greater, and sufficient to effectuate a rotational torque on rotor 230.

Any angular variation off that alignment reduces the harnessable energy. Thus, minor variations within 20 degrees may not result in much loss, although higher amounts will begin to have more impact. Orienting the shaft 250 parallel with the direction of Earth velocity would fail to harness any of the Earth velocity.

Returning now to FIG. 1, energy transfer device 110 drives an electrical generator 120 through an interface 130. Electrical generator 120 may be any type of device as known to convert rotation into electricity not discussed further herein. Interface 130 connects shaft 250 to the electrical generator 120, such that rotation of the shaft 250 causes generator 120 to generate electricity. Interface 130 may be a mechanical interface of connecting gears, or may simply be the mechanical space by which shaft 250 extends toward and connects directly to electrical generator 120.

The above considerations in some cases drive various design parameter and options of the embodiments, while others are not. Several examples are as follows.

Rotor 230 is the disclosed embodiment is a hollow cylinder to which shaft 250 is attached via end plates. However, the invention is not so limited. Rotor 230 could be solid or hollow. Rotor 230 and shaft 250 could be integral or separate components. Rotor 230 and/or shaft 250 may be made of the same materials or different materials.

The material composition of rotor 230 and/or shaft 250 can be any suitable material for the environmental conditions under which these components rotate. A dense metal such as stainless steel may be used. A combination of carbon fiber exterior around a lead interior is a non-limiting example of composite materials that can be used for the rotor.

The external shape of rotor 230 has no particular design limits other than efficiency, and would typically (but not necessarily) be cylindrical. As discussed above, the torque applied by the superconducting wire 710 is strongest proximate to the wire and drops off by a factor of 1/r² as the distance increases. So the outer portion of the rotor 230 is preferably (a) as close as possible to inner container 220 while still allowing for a gap there between with sufficient tolerance that rotor 230 can freely rotate, and (b) match the shape of the inner container 220 as closely as possible. From an efficiency standpoint, this is preferably achieved with a cylindrical rotor mounted within a toroid shape inner container 220, and the toroid winding support elements 330 having a flat surface A as discussed above. However, the invention is not so limited, and other designs may be used. A toroid having an inner diameter of 100 cm, and outer diameter of 140 cm, and an axial length of 100 cm may be appropriate.

Toroid winding support element 330 may be any material that can provide the structural support for wire 710 and withstand the operating conditions (e.g., low temperatures) under which superconductors operate. Carbon fiber is a non-limiting example of such a material. The scope of appropriate materials is known to those of skill in the art of superconductors and is not further discussed herein.

The shape of toroid winding support element 330 has no particular design limits other than efficiency. The portion of the wire 710 that is closest to the rotor 230 provides the maximum torque, and thus for efficiency the corresponding area of toroid winding support element 330 (face A) in the toroidal angle direction is preferably cylindrical in the φ direction to provide uniform application. The overall rounded rectangular shape discussed herein with respect to FIG. 6 also provides an easy and uniform surface for winding purposes, as well as providing dedicated areas for the zones of deceleration that are as far as possible from the rotor 230.

However, the invention is not so limited, and other shapes could be used, such a, pentagons, hexagons, ring (a very thin rectangle) etc., whether of uniform shape or non-uniform shape. Toroid winding support element 330 may be a single uniform structure, several connected structures, and/or several unconnected structures in proximity to each other. Thickness may be uniform around the central axis, or non-uniform. FIG. 15 shows various non-limiting examples of cross sections of toroid winding support element 330 relative to φ that illustrate these various possibilities. FIG. 16 shows various non-limiting examples of cross sections of toroid winding support element 330 relative to axial and radial directions that illustrate these various possibilities.

As discussed above, any corners of toroid winding support element 330 are preferably rounded to facilitate winding. However, there may be situations, particularly with the use of grooves 1230, where the grooves 1230 have a different shape than the outermost portion of toroid winding support element 330. For example, even though toroid winding support element 330 may have sharp corners, the grooves may be formed to a different depth around the corners, such that the bottom of the grooves provided a rounded surface.

Toroid winding support elements 330 are shown herein as of the same shape and size. While this design promotes efficient operation, the invention is not so limited, and different toroid winding support elements may of different size, shape, and/or material composition.

Further, while toroid are described herein as having various shapes, e.g., square or rectangular, this does not imply and should not be defined to require precision to such shapes. As noted herein, the outer surface of the toroid may have various modifications, e.g., rounded corners, grooves, fences, etc. The discussion of any particular shape or size herein carries a “generally” or “substantially” modifier, e.g., a “rectangular toroid” is a generally rectangular cross section toroid, and includes allowance for surface modifications as discussed herein, imperfections and other minor variances from ideal.

Toroid winding support elements 330 are preferably separated from themselves and the walls of inner container 220 by spacers 370 to allow refrigerant to circulate around superconducting wire 310. Spacers 370 are made of any material that can withstand the operating conditions. Ceramic may be appropriate for this, although the invention is not limited thereto. Spacers 370 may be individually placed around the various components, although as an alternative spaces 370 may be one large rack that holds supports 330 and is loaded into inner container 220 as a unit.

The embodiments herein show five toroid winding support elements 330. However, the invention is not so limited. The design is scalable, and can have less or more toroid winding support elements. The number would be based on the shape of each toroid winding support element and the size of the shell 310, all of which would be at least partially based on the desired ultimate output power of 100.

Superconducting wire 710 is described above as a single wire winding around a toroid winding support element 330. However, the invention is not so limited, and multiple wires may be used so long as each has some initial driving force 1410 discussed herein. In the alternative, the same wire could be wound around multiple toroid winding support elements 330. Different wires 710 are preferably of the same material and thickness, although this need not be the case.

The device power can be scaled by increasing the diameter of the rotor 230 with corresponding increases in size of the surrounding components. The larger the rotor, the greater the torque generated.

The device can be further scaled by increasing the rotation rate of the rotor at any given diameter, within the constraints of the material properties of the rotor.

As is known in the art, superconducting wires include filaments of superconducting materials, along with various other non-superconducting materials that provide strength and/or insulation that collectively provide a medium of near zero electrical resistance when in the superconducting state. Niobium compounds, such as Niobium-tin or Niobium titanium are preferable for wire 710, but the invention is not so limited. The wire 710 is preferably on the order of 1 mm in diameter, but other sizes could be used. The wire is preferably made from 25k filaments on the order of 3 microns each, but other numbers of filaments and sizes could be used. Any type of superconductor could be used.

Another non-limiting example is a thin film wire, such as yttrium barium copper oxide found in for example SuperPower® 2G HTS Wire. Such wire could be laid as described herein. As a thin film product, the structure could also be grown on the support directly. In such case this is to be considered a form of winding as discussed herein.

The scope of appropriate materials and designs of superconducting wire is known to those of skill in the art of superconductors and is not further discussed herein.

For a wire 710 made from a Niobium compound, an extremely low temperature refrigerant is preferred, such as liquid helium. However, the invention is not so limited, and any refrigerant as appropriate to induce the superconducting properties (e.g. establish a temperature below approximately 10 degrees Kelvin) in the wire 710 may be used. The scope of appropriate refrigerants is known to those of skill in the art of superconductors and is not further discussed herein.

Wire 710 as shown in FIG. 7 preferably is turned 16 times around the circumferences of toroid winding support element 330 for a single revolution; however, the invention is not so limited, and any number of turns may be made. Wire 710 of 1 mm diameter can be nested at a 2 mm pitch, although other pitches may be used. For a toroid winding support element 330 of ½-meter inner diameter, a total of 50 nested windings may be used, although the invention is not so limited and any number may be used. Preferably the windings adjacent the rotor are in parallel, and thus provide a uniform field, although the invention is not so limited.

The winding pattern of wire 710 as shown in FIG. 8 is exemplary only. As discussed above, any pattern that induces asymmetrical effects of acceleration and deceleration on rotor 230 can be used. For example, face A could include zones of acceleration, zones of deceleration, and zones of no acceleration. The only limiting factor is that the winding pattern as a whole create a net torque (clockwise or counterclockwise) on rotor 230.

Shell 310 of inner container 220 is designed to hold toroid winding support elements 330 in the refrigerant. Inner wail 314 will generally conform to the shapes dictated by the toroid winding support elements 330 and the rotor 230. One end of the shell will be attachable to seal (e.g., via welding) inner container 220 after toroid winding support elements 330 are loaded therein. The other end of the shell can be either attachable or integrally formed with inner wall 314 and outer wall 312. Outer wall 312 can have any shape, but to minimize the volume of refrigerant preferably follows the outer shape of the toroid winding support elements 330. Shell 310 may be made of any material that can survive the environmental conditions, such as by non-limiting example stainless steel.

Outer casing 210 surrounds inner container 220. Outer container 210 is preferably made from a material that can withstand the surrounding conditions (e.g., an interior vacuum), such as stainless steel. The shape of outer counter 210 is preferably dimensioned to allow for sufficient insulation, but any design could be used.

As noted above, the architecture herein is scalable. Overall, the design considerations prefer the largest maximum current of cooper pairs, which may entail a balance between selection of superconducting wire for maximum critical current vs. diameter and winding geometry. Other design consideration include increasing total number of turns for windings, making toroid winding support elements 330 thinner to increase effective acceleration in φ (which may requires more but smaller toroid winding support elements to extend to length of rotor), and increasing the radius of the toroid winding support element 330 and rotor 230. Fences 1220 or grooves 1230 could be made higher/deeper to allow for multiple overlapping windings, such as shown ion FIGS. 12E and 12F.

The rotational torque on rotor 230 can induce a rotational acceleration that may require some level of control, by way of non-limiting example to limit the rotation rate of the rotor or to match the frequency of an electrical grid. There are a variety of options for such control. Once such method is to generate a counter torque by controlling the generator field that results in the generator opposing rotation of shaft 250 in accordance with the field current. Alternatively, a physical or magnetic brake can be used to counter the torque generated by the rotor. These are all genetically represented by speed control mechanism 1710 in FIG. 17.

Referring now to FIG. 18, yet another method is to mount the transfer motor 110 on a moveable/rotating platform 1810 that can adjust the angle of the shaft 250 relative to the Earth velocity. As discussed above, maximum energy output exists when the central axis of motor 110 is perpendicular to the Earth velocity, and the output drops off as the angle alignment deviates from that perpendicular. The platform can be controlled electronically via controller 1820 to move the motor 110 into optimal alignment to achieve that maximum power level, and similarly to move motor 110 out of optimal alignment to decrease power output or to react to emergency conditions. This control method may also be used to operate the energy transfer motor in a mobile environment, such as the engine of a locomotive. In theory, motor 110 could be placed into one alignment to achieve initial rotation, and then moved into a less optimal position in which the applied acceleration is counteracted by other environmental effects such that the rotation of rotor 230 remains substantially steady.

Referring now to FIG. 19, another embodiment of a toroid winding support element 1930 is shown within motor 110. In this embodiment, toroid winding support element 1930 is a narrow rectangular toroid. For ease of discussion, toroid winding support elements 1930 are shown in FIG. 19 as having a certain thickness and distance between adjacent ones. While the embodiment could be implemented this way, toroid winding support element 1930 may be even thinner than shown, and much closer to each other (separated by sufficient minimal space to allow coolant to circulate).

Referring now of FIGS. 20-22, toroid winding support element 1930 is shown in more detail. Toroid winding support element 1930 includes wiring channels or grooves 1940 separated by sidewalls 1950 (this arrangement can be thought of as grooves per FIG. 12C or fences per FIG. 12B, depending the nature of the supporting design).

Each groove 1940 preferably has several characteristics. One such characteristic is that each groove 1940 is at a substantially equal angle to a radial extending from the central axis of the toroid winding support element 1930 (which as described above is coaxial with the rotor 230). As can be seen in FIG. 19, groove 1940 is at a 45-degree angle relative to the lateral radial shown at 1960. Similar 45-degree angles are show for radials 1962 and 1964.

Referring now to FIG. 23, superconducting wire 710 is wound in a groove 1940. The wire 710 in FIG. 23 is artistically cut away to reveal the depth of the overlapping winding within groove 1940, although it is to be understood that the wires 710 wind fully around groove 1940. In this embodiment, wire 710 is fully wound around groove 1940 before being wound on the next groove, etc. However, the invention is not so limited. The wire could be partially laid in each groove as described with respect to FIGS. 10 and 11. Multiple wires 710 could, be used, e.g. one for each groove 1940. The invention is not limited to the number of wires 710 and or the manner in which they are wound relative to any particular groove/fence.

Referring now also to FIG. 24, the groves 1940 define a specific pathway for superconducting wire 710 in a specific pattern around toroid winding support element 1930. The nature of the pattern is best described with respect to the four (4) faces of toroid winding support element, which includes the inner face A, the outer face C, and the intervening side faces B and D (shown in FIG. 22). These faces are laid flat in FIG. 24 for illustration in a planar coordinate system, although it is to be understood that the view is for reference only, and the toroid winding support element 1930 forms a three-dimensional toroidal shape.

For ease of reference, the two ends 2310 and 2390 of the superconductor 710 are shown at the juncture of the C and D surfaces of support 1930.

In the embodiment of FIGS. 23-24, superconducting wire 710 is laid along face D and runs toward face A to define a straight angled line at an angle defined by the groove 1940. At face A, which is effectively an inner edge of toroid winding support element 1930, wire 710 is laid thereabout to define an abrupt curve. The pathway of wire 710 then almost immediately transitions to face B, in which the wire 710 proceeds to define a straight angled line defined by the groove 1940 toward face C. At face D, which is effectively an outer edge of toroid winding support element 1930, wire 710 is laid around the edge to again define an abrupt curve. The pathway then continues back to face A as discussed above.

The rationale for the specific layout relates to how a particle—particularly a cooper pair within the superconducting wire 710 under proper environmental conditions—moves along a pathway described above. Due to the nature of a superconductor, once a force is applied the cooper pair, it will continue to move through the superconducting wire at a substantially constant velocity and substantially zero acceleration with respect to the entire length of wire 710.

However, the velocity and acceleration are not constant with respect to the toroidal angle φ. Referring now to FIG. 25, in face D, the linear nature of the wire 710 pathway maintains acceleration with respect to toroidal angle φ at zero (acceleration(φ)=0), but maintains a velocity (as previously established) with respect to toroidal angle φ. In face A, the abrupt curve induces a considerable acceleration with respect to toroidal angle φ (acceleration(φ)>>0), which increases the velocity. In face B, the linear nature of the wire 710 pathway returns acceleration with respect to toroidal angle φ at zero (acceleration(φ)=0), but maintains the velocity (as previously established at face A). In face C, the abrupt curve—which is in the opposite direction with respect to toroidal angle φ as compared to face A—induces a considerable deceleration with respect to pitch angle φ (acceleration(φ)>>0).

Overall, the net acceleration with respect to toroidal angle φ around the entire winding of wire 710 is zero. Since the total acceleration with respect to toroidal angle φ around the turn is equal to zero, the gravity field generated by the cooper pair acceleration is equal to the gravity field generated by the cooper pair deceleration; thus again a net zero.

However, while the gravity fields may be equal, they do not have equal effects on rotor 230. Specifically, the face A defines a zone of acceleration that is proximate to rotor 230. In contrast, the face C defines a zone of deceleration that is further away from rotor 230. Since the influence of the induced fields on rotor 230 drops off based on the square of distance, the torque applied by the proximate zone of acceleration on face A is far greater than the counter torque applied by the zone of deceleration on face C. Thus, while the total gravity fields are opposite, there is a non-zero net effect on the rotor 230, which exerts a torque to rotate rotor 230.

An approximately 45 degrees angle in grooves 1940 potentially optimizes the acceleration and deceleration of cooper pairs. Specifically, the total torque applied to rotor 230 is based on the number of wires turns on face A and the gravitational forces generated by each individual turn of the wire. A larger angle would have a more pronounced curve on face A that creates a larger force individual force per wire, but the architecture would reduce the number of wire turns that could fit on toroid winding support element 1930. Conversely, a smaller angle provides more wire turns, but each turn has a less pronounced angle with respect to phi and thus generates less force. That being said, the invention is not limited to any particular angle, and angles of approximately 5, 10, 15, 20, 25, 30, 35, 40, 45, 50, 55, 60, 65, 70, 75, 80, and 85 can be used, with each ±5 degree variance.

As noted above, FIG. 19 shows the toroid winding support elements 1930 spaced apart. FIG. 26 shows an embodiment with the toroid winding support element 1930 much closer together, which allows for considerably more toroid winding support elements 1930 in the design. Although given the size of toroid winding support element 1930 any gaps there between may not be visible, it is to be understood that such gaps may be present such as shown in FIG. 2, and may be maintained by ceramic spacers; these gaps allow the refrigerant to circulate.

Toroid winding support element 1930 preferably has an inner radius of 50 cm, an outer radius of 70 cm, and a thickness of 5 mm. Grooves 1940 are preferably recessed by a distance w into the outer skin of toroid winding support element 1930. These dimensions are only exemplary, and other configurations could, be used.

The above embodiments are discussed in relation to a scientific postulate that deceleration of cooper pairs induces a gravity field which is opposite that of the acceleration, and thus induces a counter-torque on the rotor. This postulate is based on a perception that acceleration with respect to the angle φ is a primary component of the formation of the gravity fields. However, under an alternative scientific postulate the radial acceleration with respect to the radial angle θ is also a primary component of the formation of the gravity fields. Under this postulate, there is no deceleration of the cooper pairs with respect to θ, but rather only areas of inward radial acceleration that induce a common gravity field that combines in the torque effect on the rotor. The structure of the embodiments above are the same regardless of which postulate is considered, although under the alternative postulate the resulting power may be higher because there may be more torque.

According to another embodiment of the invention shown in FIG. 28, which is particular to the alternative scientific postulate, the cross section of the toroid 2802 is significantly thinner than as discussed with respect to prior embodiments, and potentially on the order of about 1-5 mm in thickness. At this thickness, the toroid 2802 would to the eye appear to have an overall hollow cylinder shape, and such shape is to be understood to tail within the scope of toroid as used herein. By using a relatively thin toroid 2802 as compared to other embodiments herein, the of acceleration of the cooper pairs are very close to the underlying rotor, and thus exert a relatively high amount of torque as compared to a more distal relationship (where the torque would reduce with respect to distance).

Preferably only one toroid 2802 would be used, although several toroids could be connected together and/or adjacent over the length of the rotor to form a collective overall toroid 2802. The configuration of the support architecture and motor would be the same as shown in e.g., FIGS. 1-6, appropriately sized for the smaller toroid 2802.

The superconducting wire 2804 is wrapped around the outer surface of toroid 2802 in a pattern for the conductive portion that that resembles a meandering line, in that the conductive pattern has a back and forth, zig-zag, or wave shape rather than a straight line. FIG. 28 shows a single winding around the toroid 2802 with nine turns having significant spacing between each turn, although it is to be understood as per embodiments above that the turns of wires are typically much closer together (and may be touching), and overlap each other as the windings form layers over each other going back and forth over the toroid 2802.

FIG. 29 shows a zoomed in portion of the wire 2804, and demonstrates the meandering underlying conductive pattern 2902 within the insulation 2904 as repeatedly curving in a wave portion. However, the invention is not limited to any particular type of meandering pattern. For example, straighter lines with more abrupt transitions for a more traditional overall zig-zag pattern as seen in FIG. 31 could also be used.

Relative to each back and forth in die meander, there is a radial axis r (FIG. 5, and shown by an encircled x in FIG. 29) that extends through the toroid 2802 to the center of the device. Relative to that axis r, the cooper pairs moving through the conductive path will have an acceleration with respect to the rotation in the angle alpha α around radial axis r. The magnitude of acceleration at any particular point on the meander will be based in part on the rate of change of alpha, which is dictated by the shape of the meander. Thus, tighter turns in the meander pathway will produce higher acceleration than straighter areas. For a symmetrical wave pattern, the acceleration would be substantially constant with respect to a because the turns have the same shape. The magnitude of the resulting gravity field is a function of, inter alia, the magnitude of the acceleration with respect to α at any particular point along the meander.

The wire 2804 is preferably wound as a helix in one direction as shown in FIG. 28, and then overlapped with another layer in a reverse direction, etc. However, the invention is not so limited, and other patterns may be used. As discussed with respect to other embodiments, the wire 2804 may be a single wire wrapped around toroid 2802 over and over, or may be a combination of smaller overlapping wires.

Wire 2804 may be a typically superconducting wire made from materials as discussed herein and laid in the noted patterns, and the conductive pattern follows the shape of the wire itself. In another embodiment that employs thin films as in FIG. 30, a thin film wire 3002 itself may have a different pattern than the imbedded thin film superconducting conductive path 3004 within the insulating portion 3006. Specifically, the conductive path 3004 within a thin film wire is partially customizable, in that shapes other than the exterior shape of the wire can be used as the conductive path, such as shown in FIG. 30. Thus, the wire 2804 itself, while overall straight, may therefore have a meandering internal conductor 3002 within an otherwise straight wire path. FIG. 31 shows a similar design with wire 3102 and conductive path 3104. In the embodiment above, the wire 2804 itself would thus have, e.g., a helix configuration around the toroid 2802 that did not appear to the eye to be meandering, with instead the meandering pattern being embedded in the thin film structure.

In the symmetrical wave meander of the conductive pattern in FIG. 31, the acceleration is substantially constant throughout the entire pathway. In a different pattern, such as the zig-zag in FIG. 31, the acceleration would not remain constant.

In implementation, for thin film wires, the thickness of the wire (including insulators and support metals) is preferably about 100 microns, the width is preferably about 4 mm, and the conductive pattern within the thin film is preferably about 1 micron thick and preferably about 1.5 mm wide. Preferably there is no space between the wires, although this need not be the case. As a practical matter, the wires could be laid as close as possible in as many turns as possible from one end to the other of the toroid 2802, and then overlapped in multiple layers as many times as possible subject to physical limitations of the materials. For example, for a 1 meter toroid 2802, there could be 250 turns per layer end to end, with 100 or more layers.

If the entire winding assembly has the current going in a common direction, it may generate an undesirable magnetic field that could limit performance. To address this, at least some portion of the wiring pattern, and preferably substantially half of the pattern, carries current in an opposite direction from the remainder of the wiring pattern. One way this could be done is to repeatedly lay two sets of wires in alternative layers in the same wiring pattern. The ends of the two wires are then connected to different terminals of the current source, such that one each of the two layers provide the same wiring pathway but in opposite direction. The extent of the opposite direction offsets the creation of the undesirable magnet field; and this can be minimized if not outright eliminated by proper balancing of the wire layout.

The embodiments herein are directed toward the application of a generating gravitational or gravity field to induce torque in the rotor that is used to drive a power generator. However, the invention is not so limited. Any environment could represent a possible application, including but not limited to energy generation, communications, or remote imaging.

It will be apparent to those skilled in the art that modifications and variations may be made in the systems and methods of the present invention without departing from the spirit or scope of the invention. It is intended that the present invention cover the modifications and variations of this invention provided they come within the scope of the appended claims and their equivalents.

We claim:

1. A motor, comprising:
a winding support element defining an interior;
a rotor having a shaft mounted inside the interior, the shaft defining a central axis;
a superconducting wire wound around the winding support element in a winding pattern;
the winding pattern including a plurality of turns around the winding support element, comprising:
for a first portion of each turn proximate to the rotor, the wiring pattern curves with respect to a toroidal angle about the central axis; and
for a second portion of each turn distant from the rotor, the wiring pattern curves with respect to a toroidal angle about the central axis;
wherein cooper pairs travelling through the wire accelerate with respect to the toroidal angle in the first portion, and decelerate with respect to the toroidal angle in the second portion.

2. The motor of claim 1, wherein the central axis is substantially aligned perpendicular to Earth velocity.

4. The motor of claim 1, further comprising an electronic or mechanical device configured to control the rotation rate of the rotor.

5. The motor of claim 1, wherein the winding support element has a toroid shape.

6. The motor of claim 1, wherein the toroid shape has a substantially rectangular cross section.

7. The motor of claim 1, wherein the toroid shape has substantially parallel left and right faces, an inner face and an outer face, wherein the inner face is closer to the rotor than the outer face.

8. The motor of claim 7, wherein the first portion is at least partially on the inner face, and the second portion is at least partially on the outer face.

9. The motor of claim 1, wherein the winding support element includes a plurality of walls with gaps there between that generally define the wiring pattern, and the wire winds around the gaps to form the wiring pattern.

10. A motor, comprising:
a plurality of concentric winding support elements defining an interior;
each winding support element including a plurality of wiring channels that generally define a wiring pattern pathway;
a superconducting wire wound around the winding support elements in the wiring channels to thereby define a winding pattern;
a rotor having a shaft mounted inside the interior, the shaft defining a central axis of the motor;
the winding pattern including at least one zone of acceleration and at least one zone of deceleration with respect to a toroidal angle about the central axis for cooper pairs moving through the wiring pattern;
wherein, at the rotor, any net gravitation forces created by cooper pairs moving through the at least one zone of acceleration exceed any net gravitational forces created by cooper pairs moving through the at least one zone of deceleration.

11. The motor of claim 10, wherein the central axis is substantially aligned perpendicular to the north-south axis of the Earth.

12. The motor of claim 10, wherein the wiring channels are at an angle to the radial axis of the shaft.

13. The motor of claim 12, wherein the angle of the wiring channels is approximately 45 degrees.

14. The motor of claim 10, wherein a zone of acceleration is proximate to an inner face of each winding support element, and a zone of deceleration is proximate to an outer face of each winding support element.

15. The motor of claim 10, wherein the shaft is connected to a device configured to convert rotation into electricity.

16. The motor of claim 10, further comprising a device configured to control the rate of rotation of the rotor.
